(19) United States
(12) Patent Application Publication
(10) Pub. No.: US 2005/0073757 A1
(43) Pub. Date: Apr. 7, 2005

(54) Optical element mounting technique

(76) Inventors: Ian Turner, Stratham, NH (US); Ian C. Prees, Chelmsford, MA (US); Gregory G. Cappiello, Windham, NH (US); Paul R. Ouellette, North Andover, MA (US); Thomas A. Schaefer, Groveland, MA (US)

Correspondence Address: Thomas E. Anderson;Hunton & Williams, 1900 K Street, N.W., Washington, DC, 20006-1109, US

(21) Appl. No.: 10/390,152

(22) Filed: Mar. 18, 2003

Related U.S. Application Data
(60) Provisional application No. 60/364,634, filed on Mar. 18, 2002.

(51) Int. Cl. G02B 7/182

(52) U.S. Cl. 359/871

(57) ABSTRACT

A technique for attaching an optical element to a structural element is disclosed. In one particular exemplary embodiment, the technique may be realized as an optical element mounting apparatus. Such an apparatus may comprise a base structure, a first mounting pad located on a first flexure formed in the base structure, a second mounting pad located on a second flexure formed in the base structure, and a third mounting pad located on the base structure, wherein the first, second, and third mounting pads support an optical element mounted thereon.

### CROSS-REFERENCE TO RELATED APPLICATIONS

This patent application claims priority to U.S. Provisional Patent Application No. 60/364,634, filed Mar. 18, 2002, which is hereby incorporated by reference herein in its entirety.

### FIELD OF THE INVENTION

The present invention relates generally to mounting optical elements in optical modules and, more particularly, to a technique for mounting an optical element to a structural element using flexures.

### BACKGROUND OF THE INVENTION

When bonding an optical element directly to a structural element, it is common for the optical element to fracture and/or the bonding material to crack or delaminate during an elevated temperature and reduced temperature bond curing cycle. These deleterious effects typically occur as a result of thermally-induced stresses at a bi-material interface.

Consider the specific example of a glass optical element, such as an optical prism having a width of 25 millimeters, that must be mounted to a steel substrate. Assuming that the optical prism has a coefficient of thermal expansion (CTE) of 5×10⁻⁶ and the steel substrate has a CTE of 10×10⁻⁶, there exists a CTE difference of 5×10⁻⁶ between the optical prism and the steel substrate. If the optical prism is mounted to the steel substrate directly by some means such as a thin epoxy layer at room temperature (i.e., 25° C.), then at 85° C. there will exist a expansion differential across the width of the optical prism of 7.5 microns. This expansion differential is calculated as the product of the length of the interface between the optical prism and the steel substrate (i.e., 25 mm), the CTE difference between the optical prism and the steel substrate (i.e., 5×10⁻⁶), and the change in temperature (i.e., 60° C.). Since the optical prism and the steel substrate are directly bonded, this expansion differential must be taken up by additional stress in the optical prism, the steel substrate, and the epoxy. If the stress is too high, the optical prism and/or epoxy may crack, or the epoxy may delaminate. These are obviously undesirable conditions.

In order to avoid the above-described deleterious effects, the typical state of the art is to bond an optical element to a structural element only if they have reasonably close thermal expansion rates. For example, fused silica (i.e., an optical element with a coefficient of thermal expansion (CTE) of 0.5×10⁻⁶) may be reasonably safely bonded to Invar™ (i.e., a structural element with a coefficient of thermal expansion (CTE) of 1.3×10⁻⁶). However, this method is obviously limited by the number of practical structural element materials that are available.

Another method for bonding an optical element to a structural element is to spring load the optical element against reference surfaces of the structural element and allow for a sliding of the adjacent surfaces. However, this method is open to creep and non-uniform motion of the optical element.

In view of the foregoing, it would be desirable to provide a technique for mounting an optical element to a structural element which overcomes the above-described inadequacies and shortcomings in an efficient and cost effective manner.

### SUMMARY OF THE INVENTION

According to the present invention, a technique for attaching an optical element to a structural element is provided. In one particular exemplary embodiment, the technique may be realized as an optical element mounting apparatus. Such an apparatus may comprise a base structure, a first mounting pad located on a first flexure formed in the base structure, a second mounting pad located on a second flexure formed in the base structure, and a third mounting pad located on the base structure, wherein the first, second, and third mounting pads support an optical element mounted thereon.

In accordance with other aspects of this particular exemplary embodiment of the present invention, the first, second, and third mounting pads may beneficially be arranged in a triangular pattern with the third mounting pad being located substantially equidistant from the first mounting pad and the second mounting pad. The first flexure may then beneficially comprise at least one first flexure bar formed in the base structure. The first mounting pad may then beneficially be located substantially midpoint along the at least one first flexure bar. Also, the at least one first flexure bar may then beneficially be oriented substantially perpendicular to a line of action between the third mounting pad and the first mounting pad. Further, the at least one first flexure bar may then beneficially have an island portion formed therein located substantially midpoint along the at least one first flexure bar upon which the first mounting pad is located. Additionally, the first mounting pad may then beneficially be formed as a part of the at least one first flexure bar in the base structure. Alternatively, the first mounting pad may then beneficially be secured to the at least one first flexure bar by an adhesive, a metal joint, and/or welding.

Similarly, the second flexure may then beneficially comprise at least one second flexure bar formed in the base structure. The second mounting pad may then beneficially be located substantially midpoint along the at least one second flexure bar. Also, the at least one second flexure bar may then beneficially be oriented substantially perpendicular to a line of action between the third mounting pad and the second mounting pad. Further, the at least one second flexure bar may then beneficially have an island portion formed therein located substantially midpoint along the at least one second flexure bar upon which the second mounting pad is located. Additionally, the second mounting pad may then beneficially be formed as a part of the at least one second flexure bar in the base structure. Alternatively, the second mounting pad may then beneficially be secured to the at least one second flexure bar by an adhesive, a metal joint, and/or welding.

Alternatively, the first flexure may then beneficially comprise at least one first flexure arm formed in the base structure. The first mounting pad may then beneficially be located substantially at the end of the at least one first flexure arm. Also, the at least one first flexure arm may then beneficially be oriented substantially perpendicular to a line of action between the third mounting pad and the first mounting pad. Further, the at least one first flexure arm may then beneficially have an island portion formed therein located substantially at the end of the at least one first flexure arm upon which the first mounting pad is located. Additionally, the first mounting pad may then beneficially be formed as a part of the at least one first flexure arm in the base structure. Alternatively, the first mounting pad may then beneficially be secured to the at least one first flexure arm by an adhesive, a metal joint, and/or welding.

Similarly, the second flexure may then beneficially comprise at least one second flexure arm formed in the base structure. The second mounting pad may then beneficially be located substantially at the end of the at least one second flexure arm. Also, the at least one second flexure arm may then beneficially be oriented substantially perpendicular to a line of action between the third mounting pad and the second mounting pad. Further, the at least one second flexure arm may then beneficially have an island portion formed therein located substantially at the end of the at least one second flexure arm upon which the second mounting pad is located. Additionally, the second mounting pad may then beneficially be formed as a part of the at least one second flexure arm in the base structure. Alternatively, the second mounting pad may then beneficially be secured to the at least one second flexure arm by an adhesive, a metal joint, and/or welding.

In accordance with further aspects of this particular exemplary embodiment of the present invention, the base structure, the first mounting pad, the second mounting pad, and/or the third mounting pad may beneficially be formed of metal, ceramic, plastic, and/or a composite material.

In accordance with additional aspects of this particular exemplary embodiment of the present invention, the third mounting pad may beneficially be formed as a part of the base structure. Alternatively, the third mounting pad may beneficially be secured to the base structure by an adhesive, a metal joint, and/or welding.

The present invention will now be described in more detail with reference to exemplary embodiments thereof as shown in the appended drawings. While the present invention is described below with reference to preferred embodiments, it should be understood that the present invention is not limited thereto.

Those of ordinary skill in the art having access to the teachings herein will recognize additional-implementations, modifications, and embodiments, as well as other fields of use, which are within the scope of the present invention as disclosed and claimed herein, and with respect to which the present invention could be of significant utility.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a top view of a first embodiment of an optical element mounting apparatus having imbedded flexures in accordance with the present invention.

FIG. 2 is a perspective view of the optical element mounting apparatus shown in FIG. 1, along with a mounted optical element.

FIG. 3 is a top view of a second embodiment of an optical element mounting apparatus having imbedded flexures in accordance with the present invention.

FIG. 4 is a perspective view of the optical element mounting apparatus shown in FIG. 3, along with a mounted optical element.

### DETAILED DESCRIPTION OF EXEMPLARY EMBODIMENT(S)

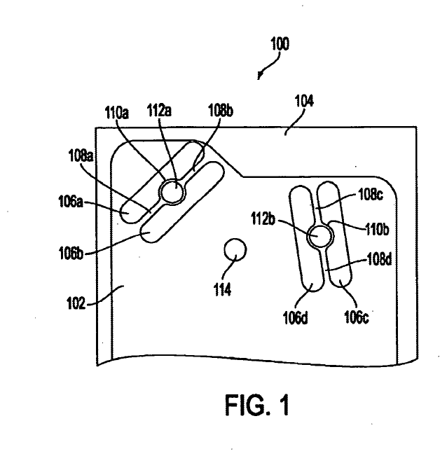

Referring to FIG. 1, there is shown a top view of a first embodiment of an optical element mounting apparatus 100 having imbedded flexures in accordance with the present invention. Specifically, the apparatus 100 comprises a base structure 102 having flexure bars 108 formed therein. The flexure bars 108 may be formed by several different methods. For example, the flexure bars 108 may be formed by milling the base structure 102 so as to form openings 106 in the base structure 102. Alternatively, the flexure bars 108 may be formed by molding the base structure 102 with openings 106 formed therein. In any case, the openings 106 are formed through the base structure 102 so that the flexure bars 108 extend across the openings 106.

At this point it should be noted that the base structure 102 may be formed of a variety of materials. For example, the base structure 102 may be formed of metal, ceramic, plastic, and/or a composite material.

As shown in FIG. 1, the flexure bars 108 may comprise island portions 110 upon which optical element mounting pads 112 located. Each island portion 110 may-be sized to accommodate the size of a respective optical element mounting pad 112. The size of each optical element mounting pad 112 may be determined by several factors including, for example, the size of an optical element to be mounted thereon, the types of materials used for the optical element mounting pad 112 and the optical element to be mounted thereon, and the level of thermally-induced stress that may be permitted between the optical element mounting pad 112 and the optical element to be mounted thereon. For instance, minimizing the size of an optical element mounting pad 112, and thereby minimizing the contact area between the optical element mounting pad 112 and the optical element to be mounted thereon, may result in a reduction in the level of thermally-induced stress between the optical element mounting pad 112 and the optical element to be mounted thereon, as will be discussed in more detail below.

At this point it should be noted that the optical element mounting pads 112 may be formed as a part of the flexure bars 108 in the base structure 102. Alternatively, the optical element mounting pads 112 may be separately formed and secured to the flexure bars 108 by an adhesive, a metal joint, and/or welding. In either case, the optical element mounting pads 112 may be formed of a variety of materials including, for example, metal, ceramic, plastic, and/or a composite material.

As shown in FIG. 1, an additional optical element mounting pad 114 is located directly on the base structure 102. That is, this additional optical element mounting pad 114 is not located on one of the flexure bars 108. All of the optical element mounting pads 112 and 114 are preferably arranged in a triangular pattern with the additional optical element mounting pad 114 preferably being located substantially equidistant from the other optical element mounting pads 112. Further, the flexure bars 108 are preferably formed in the base structure 102 such that they are oriented substantially perpendicular to lines of action between the additional optical element mounting pad 114 and the other optical element mounting pads 112. Additionally, the optical element mounting pads 112 and/or the island portions 110 formed in the flexure bars 108 are preferably located substantially midpoint along the flexure bars 108. Each of the above-mentioned features may contribute to a reduction in the level of thermally-induced stress between the optical element mounting pads 112 and 114 and the optical element to be mounted thereon, as will be discussed in more detail below.

At this point it should be noted that the additional optical element mounting pad 114 may be formed as a part of the base structure 102. Alternatively, the additional optical element mounting pad 114 may be secured to the base structure 102 by an adhesive, a metal joint, and/or welding. In either case, the additional optical element mounting pad 114 may be formed of a variety of materials including, for example, metal, ceramic, plastic, and/or a composite material.

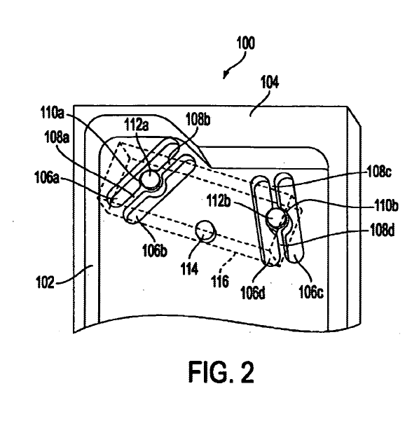

Referring to FIG. 2, there is shown a perspective view of the optical element mounting apparatus 100 shown in FIG. 1, along with a mounted optical element 116 (shown in dashed line form). The optical element 116 may be one of any number of optical-type components such as, for example, an optical lens, an optical prism, an optical diffraction grating, or an optical detector. Regardless of type, the optical element 116 may be securely mounted to the optical element mounting pads 112 and 114 as shown in FIG. 2 with minimal or no thermally-induced stresses resulting from any differences between the coefficients of thermal expansion (CTE) of the materials used for the optical element 116 and the optical element mounting pads 112 and 114. That is, as temperature changes, any expansion differential between the base structure 102 and the optical element 116 is absorbed by mechanical flexing of the flexure bars 108. With a proper choice of materials, this mechanical flexing is an elastic process over many temperature cycles and thus prevents any damage to the optical element 116 and maintains the integrity of the mounting arrangement between the optical element 116 and the optical element mounting pads 112 and 114 over the life of the module (i.e., the optical element 116 will not crack and any mounting adhesive or bonding material between the optical element 116 and the optical element mounting pads 112 and 114 will not crack or delaminate).

At this point it should be noted that the optical element 116 may be formed of a variety of optical materials such as, for example, fused silica. Also, the optical element 116 may be secured to the optical element mounting pads 112 and 114 by various means such as, for example, an adhesive, a metal joint, and/or welding.

At this point it should be noted that, while a single flexure bar 108 is shown for each optical element mounting pad 112 (and each island portion 110) in FIGS. 1 and 2, the present invention is not limited in this regard. For example, it is within the scope of the present invention to provide an optical element mounting apparatus having one or more flexure bars for each optical element mounting pad (and each island portion).

At this point it should be noted that, as shown in FIGS. 1 and 2, the base structure 102 may comprise a raised wall 104 formed thereon around an outer periphery thereof. The raised wall 104 may provide additional support to the base structure 102 (e.g., prevent warping of the base structure 102) and/or may serve to protect the optical element 116 while mounted on the mounting pads 112 and 114.

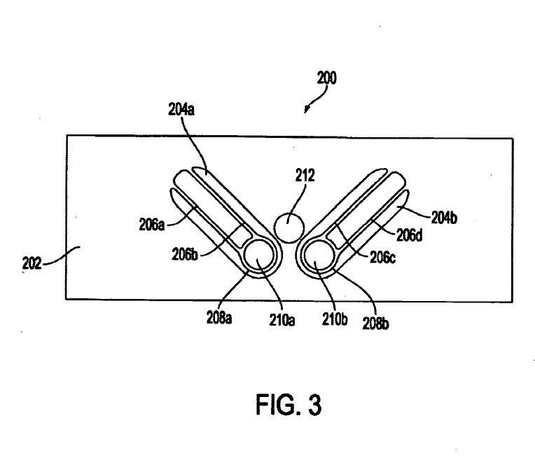

Referring to FIG. 3, there is shown a top view of a second embodiment of an optical element mounting apparatus 200 having imbedded flexures in accordance with the present invention. Specifically, the apparatus 200 comprises a base structure 202 having flexure arms 206 formed therein. Similar to the flexure bars 108 of FIG. 1, the flexure arms 206 of FIG. 3 may be formed by several different methods. For example, the flexure arms 206 may be formed by milling the base structure 202 so as to form openings 204 in the base structure 202. Alternatively, the flexure arms 206 may be formed by molding the base structure 202 with openings 204 formed therein. In any case, the openings 204 are formed through the base structure 202 so that the flexure arms 206 extend from the base structure 202 within the openings 204 in a cantilever fashion.

At this point it should be noted that the base structure 202 may be formed of a variety of materials. For example, the base structure 202 may be formed of metal, ceramic, plastic, and/or a composite material.

As shown in FIG. 3, the flexure arms 206 may comprise island portions 208 upon which optical element mounting pads 210 are located. Each island portion 208 may be sized to accommodate the size of a respective optical element mounting pad 210. The size of each optical element mounting pad 210 may be determined by several factors including, for example, the size of an optical element to be mounted thereon, the types of materials used for the optical element mounting pad 210 and the optical element to be mounted thereon, and the level of thermally-induced stress that may be permitted between the optical element mounting pad 210 and the optical element to be mounted thereon. For instance, minimizing the size of an optical element mounting pad 210, and thereby minimizing the contact area between the optical element mounting pad 210 and the optical element to be mounted thereon, may result in a reduction in the level of thermally-induced stress between the optical element mounting pad 210 and the optical element to be mounted thereon, as will be discussed in more detail below.

At this point it should be noted that the optical element mounting pads 210 may be formed as a part of the flexure arms 206 in the base structure 202. Alternatively, the optical element mounting pads 210 may be separately formed and secured to the flexure bars 206 by an adhesive, a metal joint, and/or welding. In either case, the optical element mounting pads 210 may be formed of a variety of materials including, for example, metal, ceramic, plastic, and/or a composite material.

As shown in FIG. 3, an additional optical element mounting pad 212 is located directly on the base structure 202. That is, this additional optical element mounting pad 212 is not located on one of the flexure arms 206. All of the optical element mounting pads 210 and 212 are preferably arranged in a triangular pattern with the additional optical element mounting pad 212 preferably being located substantially equidistant from the other optical element mounting pads 210. Further, the flexure arms 206 are preferably formed in the base structure 202 such that they are oriented substantially perpendicular to lines of action between the additional optical element mounting pad 212 and the other optical element mounting pads 210. Additionally, the optical element mounting pads 210 and/or the island portions 208 formed in the flexure arms 206 are preferably located substantially at the end of the flexure arms 206. Each of the above-mentioned features may contribute to a reduction in the level of thermally-induced stress between the optical element mounting pads 210 and 212 and the optical element to be mounted thereon, as will be discussed in more detail below.

At this point it should be noted that the additional optical element mounting pad 212 may be formed as a part of the base structure 202. Alternatively, the additional optical element mounting pad 212 may be secured to the base structure 202 by an adhesive, a metal joint, and/or welding. In either case, the additional optical element mounting pad 212 may be formed of a variety of materials including, for example, metal, ceramic, plastic, and/or a composite material.

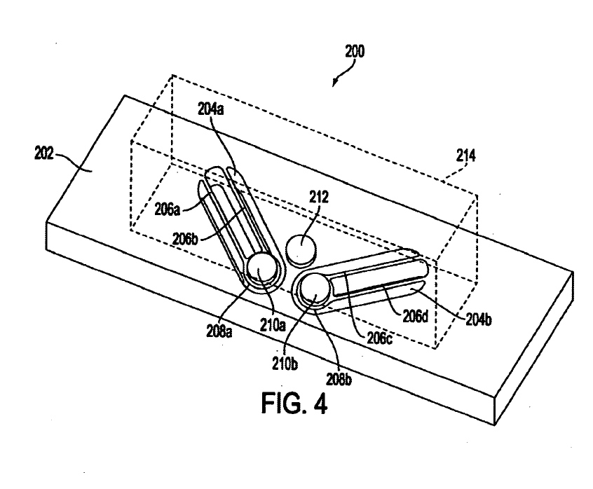

Referring to FIG. 4, there is shown a perspective view of the optical element mounting apparatus 200 shown in FIG. 3, along with a mounted optical element 214 (shown in dashed line form). The optical element 214 may be one of any number of optical-type components such as, for example, an optical lens, an optical prism, an optical diffraction grating, or an optical detector. Regardless of type, the optical element 214 may be securely mounted to the optical element mounting pads 210 and 212 as shown in FIG. 4 with minimal or no thermally-induced stresses resulting from any differences between the coefficients of thermal expansion (CTE) of the materials used for the optical element 214 and the optical element mounting pads 210 and 212. That is, as temperature changes, any expansion differential between the base structure 202 and the optical element 214 is absorbed by mechanical flexing of the flexure arms 206. With a proper choice of materials, this mechanical flexing is an elastic process over many temperature cycles and thus prevents any damage to the optical element 214 and maintains the integrity of the mounting arrangement between the optical element 214 and the optical element mounting pads 210 and 212 over the life of the module (i.e., the optical element 214 will not crack and any mounting adhesive or bonding material between the optical element 214 and the optical element mounting pads 210 and 212 will not crack or delaminate).

At this point it should be noted that the optical element 214 may be formed of a variety of optical materials such as, for example, fused silica. Also, the optical element 214 may be secured to the optical element mounting pads 210 and 212 by various means such as, for example, an adhesive, a metal joint, and/or welding.

At this point it should be noted that, while two flexure arms 206 are shown for each optical element mounting pad 210 (and each island portion 208) in FIGS. 3 and 4, the present invention is not limited in this regard. For example, it is within the scope of the present invention to provide an optical element mounting apparatus having one or more cantilevered flexure arms for each optical element mounting pad (and each island portion).

In summary, the present invention addresses the problem of attaching components having different rates of thermal expansion in an optical system. The optical system may be, for example, a Dense Wavelength Division Multiplexer (DWDM) module or an Optical Performance Monitor (OPM) module. These types of modules are typically used in telecommunications applications, and are typically required to function and survive over wide temperature ranges (e.g., −40° C. to 85° C.). Thus, the attachment method used to attach components within these modules must allow for stresses and movements caused by differential thermal expansion between the components. The components include, but are not limited to, optical elements such as optical lenses, optical prisms, optical gratings, and optical detectors. These components may be attached to each other or more typically some sort of support structure such as, for example, a platform or barrel. Thus, the present invention comprises a technique for attaching components having different rates of thermal expansion in an optical system, whereby thermal stress between the components is transferred to flexible structural members.

The present invention is not to be limited in scope by the specific embodiments described herein. Indeed, various modifications of the present invention, in addition to those described herein, will be-apparent to those of ordinary skill in the art from the foregoing description and accompanying drawings. Further, although the present invention has been described herein in the context of particular implementations in particular environments for particular purposes, those of ordinary skill in the art will recognize that its usefulness is not limited thereto and that the present invention can be beneficially implemented in any number of environments for any number of purposes.

1. An optical element mounting apparatus comprising:
a base structure;
a first mounting pad located on a first flexure formed in the base structure;
a second mounting pad located on a second flexure formed in the base structure; and
a third mounting pad located on the base structure, the first, second, and third mounting pads for supporting an optical element mounted thereon.

2. The apparatus as defined in claim 1, wherein the first, second, and third mounting pads are arranged in a triangular pattern with the third mounting pad being located substantially equidistant from the first mounting pad and the second mounting pad.

3. The apparatus as defined in claim 2, wherein the first flexure comprises at least one first flexure bar formed in the base structure.

4. The apparatus as defined in claim 3, wherein the first mounting pad is located substantially midpoint along the at least one first flexure bar.

5. The apparatus as defined in claim 4, wherein the at least one first flexure bar is oriented substantially perpendicular to a line of action between the third mounting pad and the first mounting pad.

6. The apparatus as defined in claim 4, wherein the at least one first flexure bar has an island portion formed therein located substantially midpoint along the at least one first flexure bar upon which the first mounting pad is located.

7. The apparatus as defined in claim 4, wherein the first mounting pad is formed as a part of the at least one first flexure bar in the base structure.

8. The apparatus as defined in claim 4, wherein the first mounting pad is secured to the at least one first flexure bar by one or more of an adhesive, a metal joint, and welding.

9. The apparatus as defined in claim 2, wherein the second flexure comprises at least one second flexure bar formed in the base structure.

10. The apparatus as defined in claim 9, wherein the second mounting pad is located substantially midpoint along the at least one second flexure bar.

11. The apparatus as defined in claim 10, wherein the at least one second flexure bar is oriented substantially perpendicular to a line of action between the third mounting pad and the second mounting pad.

12. The apparatus as defined in claim 10, wherein the at least one second flexure bar has an island portion formed therein located substantially midpoint along the at least one second flexure bar upon which the second mounting pad is located.

13. The apparatus as defined in claim 10, wherein the second mounting pad is formed as a part of the at least one second flexure bar in the base structure.

14. The apparatus as defined in claim 10, wherein the second mounting pad is secured to the at least one second flexure bar by one or more of an adhesive, a metal joint, and welding.

15. The apparatus as defined in claim 2, wherein the first flexure comprises at least one first flexure arm formed in the base structure.

16. The apparatus as defined in claim 15, wherein the first mounting pad is located substantially at the end of the at least one first flexure arm.

17. The apparatus as defined in claim 16, wherein the at least one first flexure arm is oriented substantially perpendicular to a line of action between the third mounting pad and the first mounting pad.

18. The apparatus as defined in claim 16, wherein the at least one first flexure arm has an island portion formed therein located substantially at the end of the at least one first flexure arm upon which the first mounting pad is located.

19. The apparatus as defined in claim 16, wherein the first mounting pad is formed as a part of the at least one first flexure arm in the base structure.

20. The apparatus as defined in claim 16, wherein the first mounting pad is secured to the at least one first flexure arm by one or more of an adhesive, a metal joint, and welding.

21. The apparatus as defined in claim 2, wherein the second flexure comprises at least one second flexure arm formed in the base structure.

22. The apparatus as defined in claim 21, wherein the second mounting pad is located substantially at the end of the at least one second flexure arm.

23. The apparatus as defined in claim 22, wherein the at least one second flexure arm is oriented substantially perpendicular to a line of action between the third mounting pad and the second mounting pad.

24. The apparatus as defined in claim 22, wherein the at least one second flexure arm has an island portion formed therein located substantially at the end of the at least one second flexure arm upon which the second mounting pad is located.

25. The apparatus as defined in claim 22, wherein the second mounting pad is formed as a part of the at least one second flexure arm in the base structure.

26. The apparatus as defined in claim 22, wherein the second mounting pad is secured to the at least one second flexure arm by one or more of an adhesive, a metal joint, and welding.

27. The apparatus as defined in claim 1, wherein the base structure is formed of one or more of a metal, ceramic, plastic, and composite material.

28. The apparatus as defined in claim 1, wherein the first mounting pad is formed of one or more of a metal, ceramic, plastic, and composite material.

29. The apparatus as defined in claim 1, wherein the second mounting pad is formed of one or more of a metal, ceramic, plastic, and composite material.

30. The apparatus as defined in claim 1, wherein the third mounting pad is formed as a part of the base structure.

31. The apparatus as defined in claim 1, wherein the third mounting pad is secured to the base structure by one or more of an adhesive, a metal joint, and welding.

32. The apparatus as defined in claim 1, wherein the third mounting pad is formed of one or more of a metal, ceramic, plastic, and composite material.
